(19) United States
(12) Patent Application Publication
(10) Pub. No.: US 2003/0183283 A1
(43) Pub. Date: Oct. 2, 2003

(54) Pressure relief valve assembly for a steam cleaning device

(76) Inventor: Yin-Tao Liu, Taichung Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/115,201

(22) Filed: Mar. 29, 2002

(51) Int. Cl. F16K 15/00

(52) U.S. Cl. 137/599.18

(57) ABSTRACT

A pressure relief valve assembly for a steam cleaning device, includes a tubular member adapted to be communicated with a venting port of the device. An axially extending plunger member has a stem segment disposed movably in and spaced apart from the tubular member by a surrounding clearance which is communicated with the venting port via a surrounding seat portion, and a valve segment movable to abut against or to withdraw from the seat portion so as to interrupt or permit communication between the clearance and the seat portion. A radially extending steam releasing port is communicated with the clearance for discharging of excess steam through the clearance when the stem segment is in an actuated position.

### BACKGROUND OF THE INVENTION

1. Field of the Invention

This invention relates to a pressure relief valve assembly, more particularly to a pressure relief valve assembly for a steam cleaning device.

2. Description of the Related Art

Referring to FIGS. 1 and 2, a conventional steam cleaning device is shown to include a housing 10, a pressure relief valve assembly 20, a boiler 30, and a steam nozzle 303 covered by a cover plate 304, and a flexible tube 302 interconnecting the boiler 30 and the steam nozzle 303.

The valve assembly 20 includes a tubular member 40 which is communicated with a venting port 301 of the boiler 30 and which is secured to the housing 10. A barrel 204 is secured to an upper portion of the tubular member 40. A plunger member 203 includes a stem portion which is received slidably in the barrel 204 and which is spaced apart from an inner surrounding surface of the barrel 204 by a surrounding clearance 100 that communicates with the venting port 301, and a surrounding abutment wall 2031 which extends radially and outwardly to abut against a lower end wall of the barrel 204. A depressing knob 201 has a lower mounting seat 202 which is connected to an upper portion of the plunger member 203. A spring 205 is disposed between the barrel 204 and the lower mounting seat 202. A spring-biased valve 207 is disposed to close or open an outlet 2022 in the lower mounting seat 202. In use, a bursting stream of excess steam in a passage 2032 in the plunger member 203 can move the valve 207 upwards against the biasing action of a spring 209 to open communication between the passage 2032 and an outlet 208 in the depressing knob 201 to permit discharge of the excess steam.

Referring to FIG. 3, after use, when the depressing knob 201 is pressed downward, the plunger member 203 displaces downward so that the surrounding abutment wall 2031 moves away from the barrel 204, thereby permitting communication between the clearance 100 and the venting port 301. Thus, the excess steam in the boiler 30 can be discharged out of the barrel 204 via the clearance 100 for safety purposes.

However, since the discharged steam is very near the depressing knob 201, heat of the steam is liable to injure the user's hand during pressing of the depressing knob 201.

### SUMMARY OF THE INVENTION

The object of the present invention is to provide a pressure relief valve assembly for a steam cleaning device, which can prevent hot steam from injuring the user.

According to this invention, the pressure relief valve assembly comprises a tubular member which includes a proximate end wall with a surrounding seat portion that is adapted to be communicated with a venting port of a steam cleaning device and that confines an internal port, a distal end wall opposite to the proximate end wall along an axis, and a barrel body extending between peripheries of the proximate and distal end walls. The barrel body includes outer and inner surrounding surfaces opposite to each other in radial directions relative to the axis. The inner surrounding surface confines an accommodation chamber extending along the axis to be communicated with the internal port. A plunger member includes a stem segment which extends along the axis, and which is received in the accommodation chamber, which is slidable along the axis relative to the barrel body between an actuated position and a normal position, and which is spaced apart from the inner surrounding surface of the barrel body in radial directions relative to the axis by a surrounding clearance that extends to be communicated with the surrounding seat portion, an actuated segment which is connected to the stem segment and which extends outwardly of the distal end wall so as to be depressed to move the stem segment from the normal position to the actuated position, and a valve segment which is connected to the stem segment and distal to the actuated segment along the axis, which extends outwardly of the proximate end wall via the internal port, and which forms a surrounding abutment wall that confronts the surrounding seat portion. As such, in the normal position, the surrounding abutment wall abuts against the surrounding seat portion so as to interrupt communication between the surrounding clearance and the surrounding seat portion. In the actuated position, the surrounding abutment wall is remote from the surrounding seat portion so as to permit communication between the surrounding clearance and the surrounding seat portion. A steam releasing port is disposed in the outer surrounding surface, and extends radially relative to the axis through the inner surrounding surface to be communicated with the surrounding clearance. A biasing member is disposed to bias the stem segment to move from the actuated position to the normal position.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional schematic view of a conventional steam cleaning device;

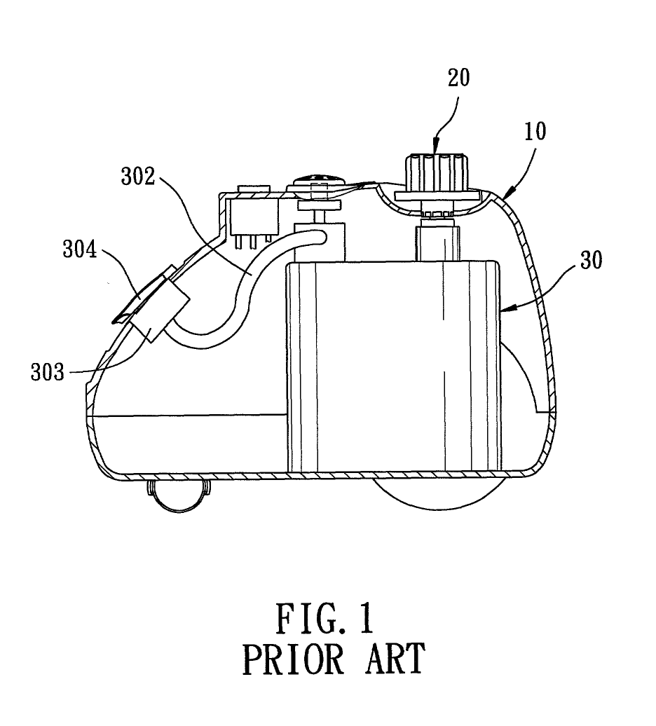

FIG. 2 is a sectional view showing a pressure relief valve assembly of the conventional steam cleaning device in a state of use;

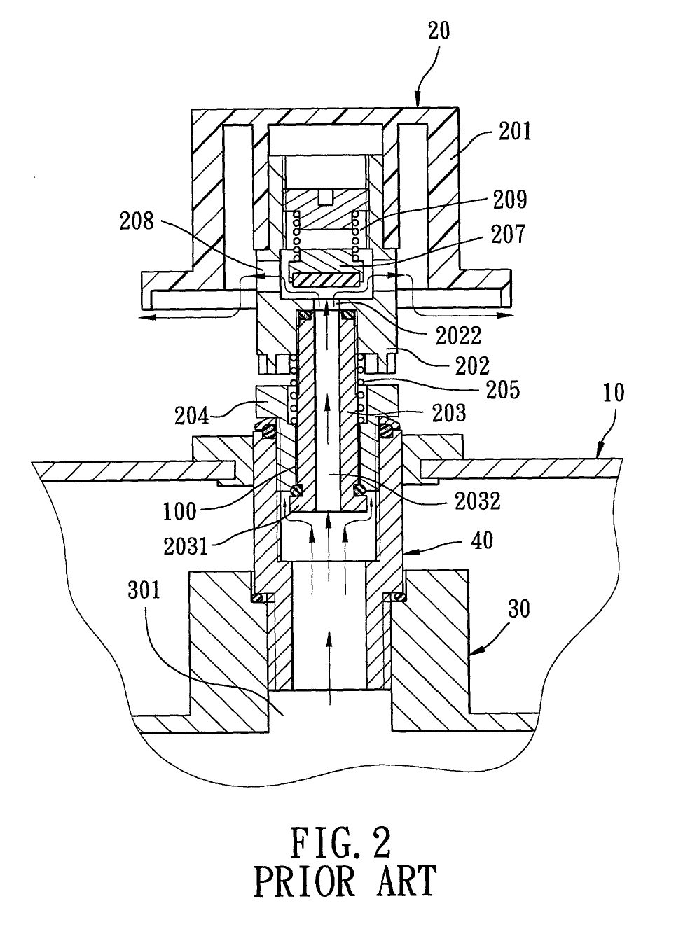

FIG. 3 is a sectional view showing the valve assembly of the conventional steam cleaning device in a pressure releasing state;

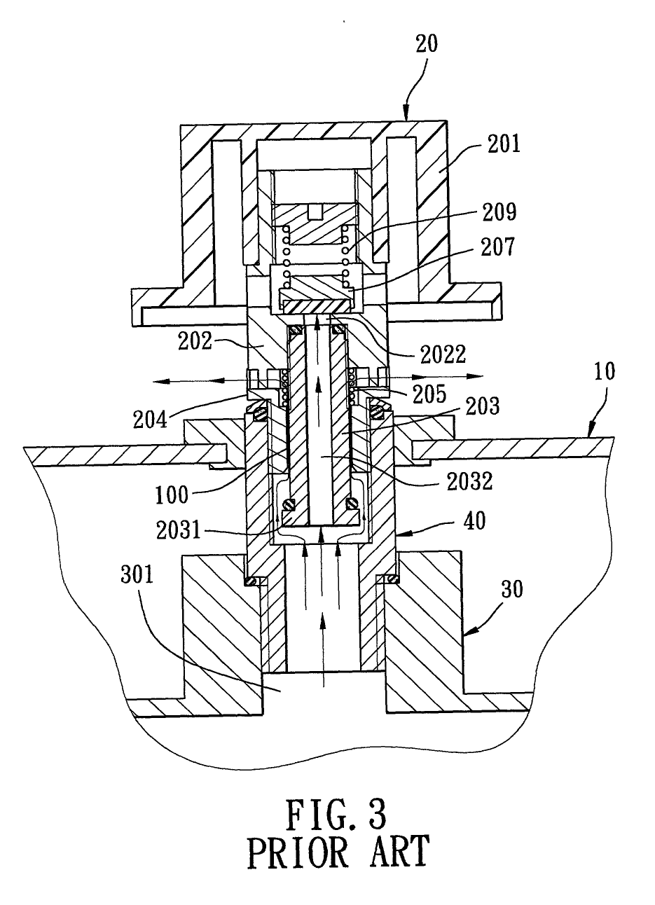

FIG. 4 is a sectional view of a first preferred embodiment of a pressure relief valve assembly according to this invention when incorporated in a steam cleaning device;

FIG. 5 is a sectional view of the first preferred embodiment in a state of use;

FIG. 6 is a sectional view showing the first preferred embodiment in a pressure releasing state;

FIG. 7 is a sectional view of a second preferred embodiment of the pressure relief valve assembly according to this invention;

FIG. 8 is a sectional view of the second preferred embodiment in a state of use; and

FIG. 9 is a sectional view showing the second preferred embodiment in a pressure releasing state.

### DETAILED DESCRIPTION OF THE PREFERRED EMBODIMENTS

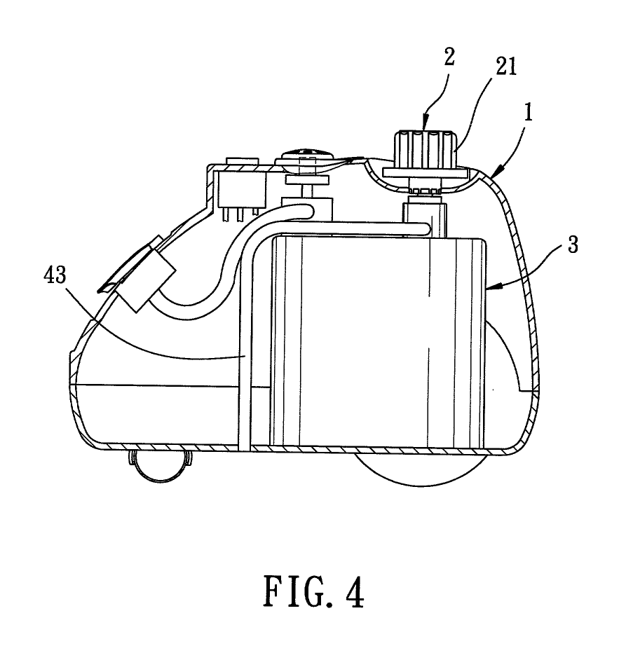

Referring to FIGS. 4 to 6, a pressure relief valve assembly 2 of this invention is shown to be mounted on a housing 1 of a steam cleaning device. The steam cleaning device further includes a boiler 3 with a venting port 31. The first preferred embodiment of the pressure relief valve assembly 2 according to the present invention is shown to comprise a tubular member 4, a plunger member 23, a force transmitting member 22, and a depressing knob 21.

The tubular member 4 includes a coupling body 44 which is secured to an inner peripheral wall 11 of the housing 1, and which is inserted into the housing 1 to be connected to the venting port 31 of the boiler 3, and a barrel body. The barrel body includes upper and lower sections 24,26 which are spaced apart from each other in an axial direction to confine a surrounding space 29. The upper section 24 is secured sealingly to the coupling body 44, and has a distal end wall 241. The lower section 26 is secured sealingly in the coupling body 44 by an O-ring seal 261, and has a proximate end wall which is disposed opposite to the distal end wall 241 along an axis in the axial direction. The proximate end wall has a surrounding seat portion 262 which is adapted to be communicated with the venting port 31 and which confines an internal port. The lower section 26 has outer and inner surrounding surfaces opposite to each other in radial directions relative to the axis. The inner surrounding surface confines an accommodation chamber which extends along the axis to be communicated with the internal port of the surrounding seat portion 262 and the surrounding space 29. A steam releasing port 41 is disposed in the outer surrounding surface, extends radially relative to the axis through the inner surrounding surface, and is communicated with the accommodation chamber via the surrounding space 29.

The plunger member 23 includes a stem segment 234, an actuated segment 235, and a valve segment 231. The stem segment 234 extends along the axis and is received in the accommodation chamber of the tubular member 4. The stem segment 234 is slidable along the axis relative to the barrel body between an actuated position and a normal position, and is spaced apart from the inner surrounding surface in radiation directions relative to the axis by a surrounding clearance 200 which extends to communicate the surrounding seat portion 262 with the steam releasing port 41 via the surrounding space 29. In addition, an O-ring seal 242, a pad 28, and a coiled spring 27 are sleeved on the stem segment 234 and are disposed in the surrounding space 29 so as to bias the upper section 24 away from the lower section 26 to thereby maintain fluid communication between the surrounding clearance 200 and the steam releasing port 41.

The actuated segment 235 is formed integrally with the stem segment 234, and extends outwardly of the distal end wall 241 so as to be depressed to move the stem segment 234 from the normal position to the actuated position. The actuated segment 235 has a peripheral seat wall 236 which confines an outlet port 2361 surrounding the axis.

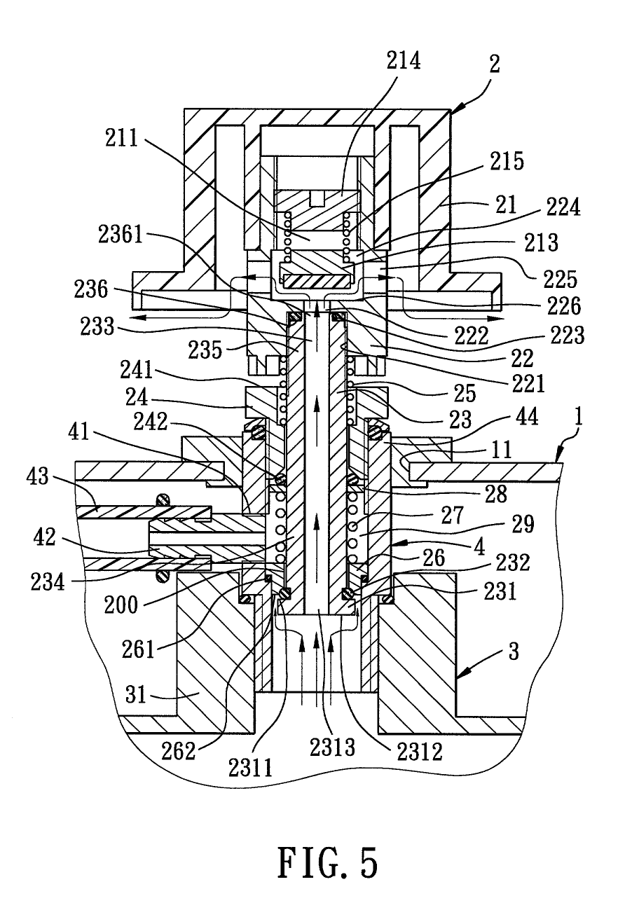

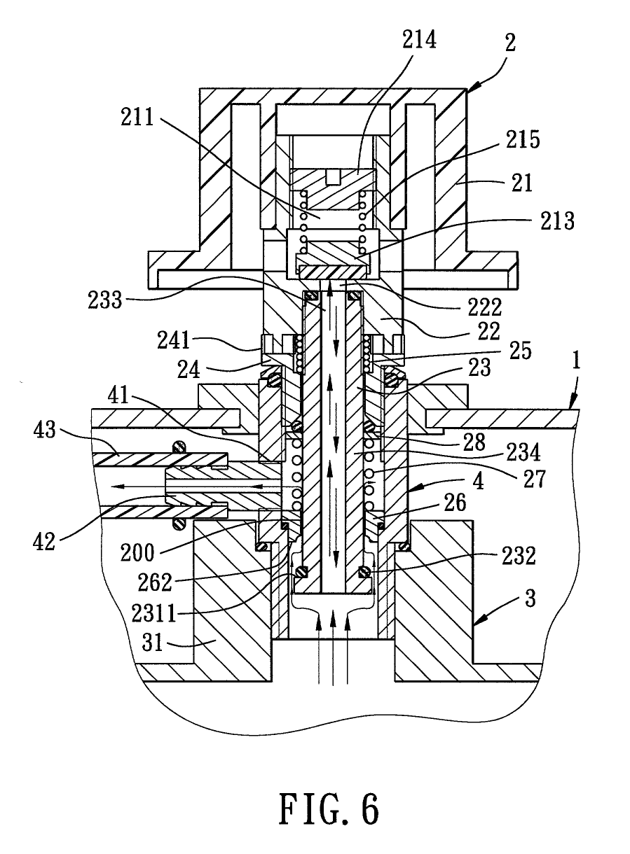

The valve segment 231 is formed integrally with the stem segment 234, is distal to the actuated segment 235 along the axis, and extends outwardly of the proximate end wall 262 via the internal port. The valve segment 231 is formed with a surrounding abutment wall 2311 which confronts the surrounding seat portion 262 and which is provided with an O-ring seal 232 thereon. As such, in the normal position, as shown in FIG. 5, the surrounding abutment wall 2311 abuts against the surrounding seat portion 262 so as to interrupt communication between the surrounding clearance 200 and the surrounding seat portion 262. In the actuated position, as shown in FIG. 6, the surrounding abutment wall 2311 is remote from the surrounding seat portion 262 so as to permit communication between the surrounding clearance 200 and the surrounding seat portion 262. In addition, the valve segment 231 further has a surrounding bottom wall 2312 which is opposite to the surrounding abutment wall 2311 in the axial direction and which confines an inner port 2313 surrounding the axis. A passage 233 extends along the axis and upwards and downwards to be communicated with the outlet port 2361 and the inner port 2313 respectively.

The force transmitting member 22 is disposed to be manually depressible, and has upper and lower segments opposite to each other in the axial direction, and a middle segment interposed therebetween. A first biasing member 25 is disposed between the actuated segment 235 and the lower segment of the force transmitting member 22 to bias the stem segment 234 to move from the actuated position to the normal position.

The lower segment has a recess 221 which extends towards the middle segment and which terminates at an inner depressing wall surface 223 that engages the peripheral seat wall 236 of the actuated segment 235 via an O-ring seal. The middle segment has an inner cavity 224 extending in the axial direction to accommodate a closure disk 213. A venting outlet 225 extends radially to communicate with the inner cavity 224. An outer depressing wall surface 226 confronts the inner cavity 224, and is disposed opposite to the inner depressing wall surface 223 in the axial direction. The outer depressing wall surface 226 has a communicating duct 222 which extends in the axial direction to communicate the outlet port 2361 with the inner cavity 224. Thus, the closure disk 213 is movable in the axial direction between a closed position, where the closure disk 213 abuts against the outer depressing wall surface 226 to close the outlet port 2361, and an open position, where the closure disk 213 is remote from the outer depressing wall surface 226 as a result of being lifted by a bursting stream of excess steam.

The upper segment has an outer cavity 211 extending in the axial direction to be communicated with the inner cavity 224. A second biasing member 215 has a lower end which is secured to the closure disk 213, and an upper end which extends from the lower end upwardly and into the outer cavity 211 so as to bias the closure disk 213 to move to the closed position. A biasing force adjusting member 214, such as a screw nut, is disposed in the outer cavity 211, and is retainingly movable relative to the upper segment along the axis. The adjusting member 214 engages the upper end of the second biasing member 215 so as to adjust biasing force of the second biasing member 215 by virtue of incremental movement thereof relative to the upper segment.

The depressing knob 21 covers the upper cavity 211 and is movable in the axial direction so as to permit downward movement of the force transmitting member 22 to depress the actuated segment 235.

After use, referring to FIG. 6, depression of the depressing knob 21 by a user's finger moves the stem segment 234 of the plunger member 23 downwardly to the actuated position. The excess steam remaining in the boiler 3 can flow through the surrounding clearance 200 and can be discharged via the steam releasing port 41. Preferably, a connecting head 42 is connected to the steam releasing port 41 to engage a flexible tube 43 which extends downwardly to a bottom of the housing 1 of the steam cleaning device so as to result in preventing heat injury.

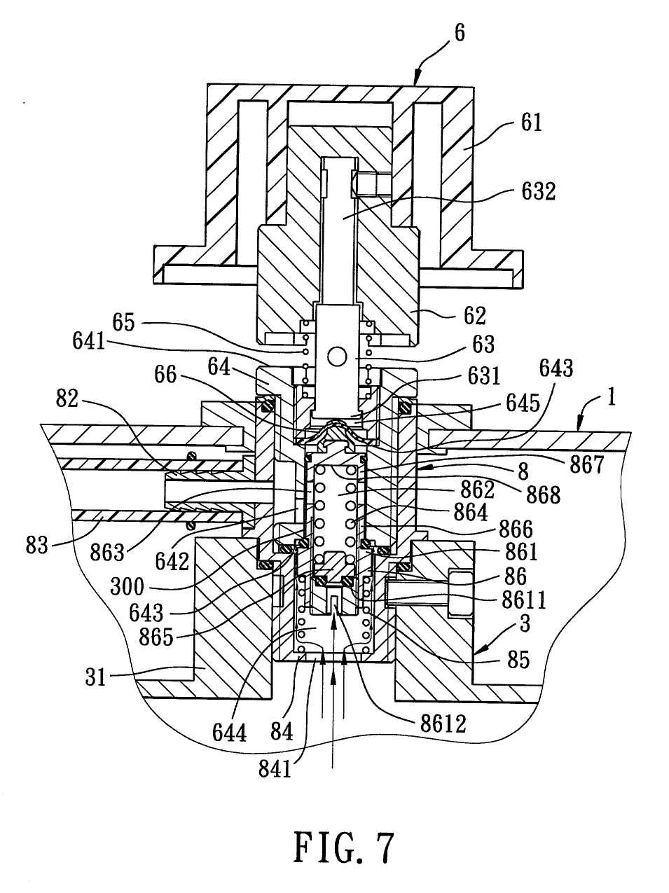

Referring to FIGS. 7 to 9, the second preferred embodiment of this invention is shown to have a construction similar to that of the previous embodiment. A pressure relief valve assembly 6 of this embodiment includes a tubular member 8, a plunger member 86, and a depressing knob 61.

A mounting wall 84 is disposed below and is spaced apart from the surrounding seat portion 643 by an accommodation space 644. The mounting wall 84 has a second communicating port 841 which extends in the axial direction to be adapted to be communicated with the venting port 31 of the boiler 3 so as to establish communication between the accommodation space 644 and the venting port 31. The first biasing member 85 is disposed between the mounting wall 84 and the valve segment 861 of the plunger member 86.

The stem segment 866 of the plunger member 86 confines an upper cavity 862 which extends in the axial direction and towards the actuated segment 867 and which terminates at an upper limit wall 868, and has an outlet port 863 which is disposed proximate to the upper limit wall 868 and which extends radially to communicate the steam releasing port 642 with the upper cavity 862. The valve segment 861 includes a surrounding shoulder seat 8611 which is disposed to confront the upper cavity 862 and which confines an inner port 8612 along the axis to communicate the upper cavity 862 with the accommodation space 644.

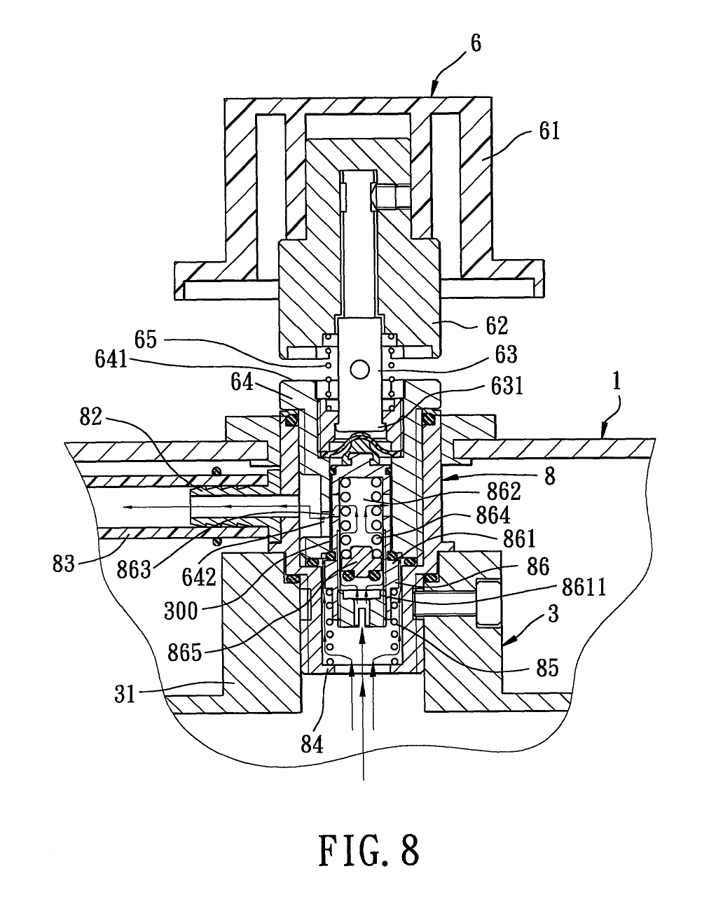

The closure disk 865 is disposed in the upper cavity 862 and is movable between a closed position, as shown in FIG. 7, where the closure disk 865 abuts against the surrounding shoulder seat 8611 to close the inner port 8612, and an open position, as shown in FIG. 8, where the closure disk 865 is remote from the inner port 8612 as a result of being lifted by a bursting stream of the excess steam. A biasing member 864 is disposed in the upper cavity 862 to bias the closure disk 865 to move to the closed position.

The distal end wall 643 has a communicating opening which extends in the axial direction to be communicated with the accommodation chamber of the barrel body, thereby permitting the actuated segment 867 to extend outwardly of the distal end wall 643. An upper surrounding wall 64 extends from the periphery of the distal end wall 643 upwardly and terminates at a surrounding rest end 641, and confines a receiving cavity 645 which extends in the axial direction to be communicated with the communicating opening so as to receive the actuated segment 867.

A diaphragm 66 is disposed on the distal end wall 643 and confronts the receiving cavity 645. The diaphragm 66 is disposed to seal the communicating opening and is associated with the actuated segment 867.

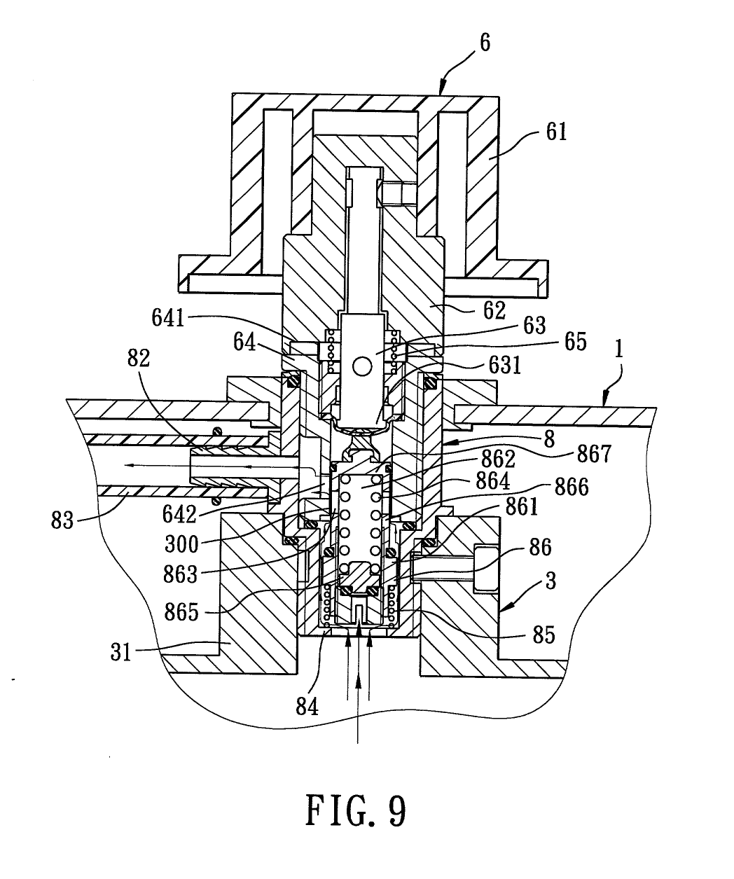

An actuating rod 63 has a depressing end 631 which is disposed in the receiving cavity 645 to push the actuated segment 867 downwards through the diaphragm 66 so as to move the stem segment 866 to the actuated position, as shown in FIG. 9, and an actuated end 632 which extends from the depressing end 631 and upwardly of the surrounding rest end 641.

The depressing knob 61 is disposed to press the actuated end 632 downwards, and includes a surrounding head end 62 which surrounds the actuated end 632 and which is spaced apart from the surrounding rest end 641 when the stem segment 866 is in the normal position. A biasing member 65 is disposed to bias the surrounding head end 62 to move away from the surrounding rest end 641.

After use, referring to FIG. 9, depression of the depressing knob 61 by a user's finger moves the stem segment 866 of the plunger member 86 downwardly to the actuated position. The excess steam remaining in the boiler 3 can flow through the surrounding clearance 300 and can be discharged from the steam releasing port 642. A connecting head 82 is connected to the steam releasing port 642 to engage a flexible tube 83 which can extend downwardly to a bottom of the housing 1 of the steam cleaning device. While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A pressure relief valve assembly for a steam cleaning device which includes a venting port for outflow of an excess steam, comprising:
a tubular member including
a proximate end wall with a first periphery, and having a surrounding seat portion which is adapted to communicate with the venting port, and which confines an internal port,
a distal end wall with a second periphery, and disposed to be opposite to said proximate end wall along an axis in an axial direction, and
a barrel body extending between said first and second peripheries, and including outer and inner surrounding surfaces opposite to each other in radial directions relative to the axis, said inner surrounding surface confining an accommodation chamber which extends along the axis to be communicated with said internal port;
a plunger member including
a stem segment extending along the axis and received in said accommodation chamber, said stem segment being disposed to be slidable along the axis relative to said barrel body between an actuated position and a normal position, and being spaced apart from said inner surrounding surface in the radial directions by a surrounding clearance that extends to be communicated with said surrounding seat portion,
an actuated segment connected to said stem segment and extending outwardly of said distal end wall so as to be depressed to move said stem segment from the normal position to the actuated position, and
a valve segment connected to said stem segment and distal to said actuated segment along the axis, said valve segment extending outwardly of said proximate end wall via said internal port and forming a surrounding abutment wall which confronts said surrounding seat portion such that, in the normal position, said surrounding abutment wall abuts against said surrounding seat portion so as to interrupt communication between said surrounding clearance and said surrounding seat portion, and such that, in the actuated position, said surrounding abutment wall is remote from said surrounding seat portion so as to permit communication between said surrounding clearance and said surrounding seat portion;
a steam releasing port disposed in said outer surrounding surface, and extending radially relative to the axis through said inner surrounding surface to be communicated with said surrounding clearance; and
a first biasing member disposed to bias said stem segment to move from the actuated position to the normal position.

2. The pressure relief valve assembly of claim 1, wherein:
said valve segment has a surrounding bottom wall which is opposite to said surrounding abutment wall in the axial direction and which confines an inner port surrounding the axis;
said actuated segment has a peripheral seat wall which confines an outlet port surrounding the axis; and
said plunger member has a passage which extends along the axis and upwards and downwards to be communicated with said outlet and inner ports respectively,
said pressure relief valve assembly further comprising:
a first closure disk disposed to be movable between a closed position, where said first closure disk is placed to close said outlet port, and an open position, where said first closure disk is remote from said outlet port as a result of being lifted by a bursting stream of the excess steam; and
a second biasing member disposed to bias said first closure disk to move to the closed position.

3. The pressure relief valve assembly of claim 2, further comprising a force transmitting member which is disposed to be manually depressible and which has upper and lower segments opposite to each other in the axial direction, and a middle segment interposed therebetween, said lower segment having a recess extending towards said middle segment and terminating at an inner depressing wall surface which engages said peripheral seat wall, said middle segment having an inner cavity therein which extends in the axial direction to accommodate movement of said first closure disk between the closed and open positions, a venting outlet extending radially to be communicated with said inner cavity, and an outer depressing wall surface confronting said inner cavity and opposite to said inner depressing wall surface in the axial direction, said outer depressing wall surface having a communicating duct extending in the axial direction to communicate said outlet port with said inner cavity, and abutting against said first closure disk to block the excess steam from bursting into said inner cavity via said communicating port when said first closure disk is moved to the closed position.

4. The pressure relief valve assembly of claim 3, wherein said upper segment has an outer cavity extending in the axial direction to be communicated with said inner cavity, said second biasing member having a lower end secured to said first closure disk, and an upper end extending from said lower end upwardly and into said outer cavity, said pressure relief valve assembly further comprising a biasing force adjusting member which is disposed in said outer cavity and which is retainingly movable relative to said upper segment along the axis, said biasing force adjusting member engaging said upper end of said second biasing member so as to adjust biasing force of said second biasing member by virtue of incremental movement of said biasing force adjusting member relative to said upper segment.

5. The pressure relief valve assembly of claim 4, further comprising a first depressing knob which is configured to cover said outer cavity and to be movable in the axial direction so as to permit downward movement of said force transmitting member to depress said actuated segment.

6. The pressure relief valve assembly of claim 5, wherein said first biasing member is disposed between said actuated segment and said lower segment.

7. The pressure relief valve assembly of claim 6, wherein said barrel body includes upper and lower sections spaced apart from each other in the axial direction to confine a surrounding space which communicates said surrounding clearance with said steam releasing port, said pressure relief valve assembly further comprising a coiled spring which is sleeved on said plunger member and disposed in said surrounding space so as to bias said upper section away from said lower section to thereby maintain fluid communication between said surrounding clearance and said steam releasing port.

8. The pressure relief valve assembly of claim 1, further comprising a mounting wall which is disposed below and which is spaced apart from said surrounding seat portion by an accommodation space, and which has a communicating port extending in the axial direction to be adapted to be communicated with the venting port, thereby establishing communication between said accommodation space and the venting port, said first biasing member being disposed between said mounting wall and said valve segment.

9. The pressure relief valve assembly of claim 8, wherein said stem segment confines an upper cavity extending in the axial direction and towards said actuated segment and terminating at an upper limit wall, and has an outlet port disposed proximate to said upper limit wall and extending radially to communicate said steam releasing port with said upper cavity, said valve segment including a surrounding shoulder seat which is disposed to confront said upper cavity and which confines an inner port along the axis to communicate said upper cavity with said accommodation space,
said pressure relief valve assembly further comprising a second closure disk disposed in said upper cavity and movable between a closed position, where said second closure disk abuts against said surrounding shoulder seat to close said inner port, and an open position, where said second closure disk is remote from said inner port as a result of being lifted by a bursting stream of the excess steam; and
a third biasing member disposed in said upper cavity to bias said second closure disk to move to the closed position.

10. The pressure relief valve assembly of claim 9, wherein said distal end wall has a communicating opening which extends in the axial direction to be communicated with said accommodation chamber thereby permitting said actuated segment to extend outwardly of said distal end wall,
said pressure relief valve assembly further comprising
an upper surrounding wall extending upwardly from said second periphery of said distal end wall, terminating at a surrounding rest end, and confining a receiving cavity which extends in the axial direction to be communicated with said communicating opening so as to receive said actuated segment;
a diaphragm disposed on said distal end wall and confronting said receiving cavity, said diaphragm being disposed to seal around said communicating opening, and being associated with said actuated segment; and
an actuating rod having a depressing end which is disposed in said receiving cavity to push said actuated segment downwards so as to move said stem segment to the actuated position, and an actuated end which extends from said depressing end and upwardly of said surrounding rest end.

11. The pressure relief valve assembly of claim 10, further comprising a second depressing knob which is disposed to press said actuated end downwards and which includes a surrounding head end disposed to surround said actuated end and to be spaced apart from said surrounding rest end when said stem segment is in the normal position, and
a fourth biasing member disposed to bias said surrounding head end to move away from said surrounding rest end.
